(19) United States
(12) Patent Application Publication
(10) Pub. No.: US 2023/0340937 A1
(43) Pub. Date: Oct. 26, 2023

(54) Wind Turbine Blades Having System Integrated Tips and Methods of Making Using Additive Manufacturing

(71) Applicants: Carsten H. Westergaard, Houston, TX (US); National Technology & Engineering Solutions of Sandia, LLC, Albuquerque, NM (US)

(72) Inventors: Brent C. HOUCHENS, Tacoma, WA (US); Paul G. CLEM, Albuquerque, NM (US); Daniel R. HOUCK, Albuquerque, NM (US); Salvador B. RODRIGUEZ, Albuquerque, NM (US); Christopher Lee KELLEY, Albuquerque, NM (US); David C. MANIACI, Albuquerque, NM (US); Kevin R. MOORE, Edgewood, NM (US); Joshua PAQUETTE, Albuquerque, NM (US); Julia N. TILLES, Tijeras, NM (US); Michelle WILLIAMS, Albuquerque, NM (US); Carsten H. WESTERGAARD, Houston, TX (US)

(21) Appl. No.: 18/136,770

(22) Filed: Apr. 19, 2023

Related U.S. Application Data
(60) Provisional application No. 63/332,777, filed on Apr. 20, 2022.

(51) Int. Cl. B29D 99/00; F03D 1/06

(52) U.S. Cl. CPC F03D 1/0633; B29D 99/0028; B33Y 80/00

(57) ABSTRACT

The present invention is directed to wind turbine blades that include an additive manufactured system-integrated tip. The disclosed wind turbine blades reduce the levelized cost of electricity (LCOE) for both new and existing wind turbines.

### CROSS-REFERENCE TO RELATED APPLICATIONS

This application claims priority to provisional patent application U.S. Ser. No. 63/332,777, entitled “WIND TURBINE BLADES HAVING SYSTEM INTEGRATED TIP AND METHODS OF MAKING USING ADDITIVE MANUFACTURING,” filed Apr. 20, 2022, the disclosure of which is incorporated herein by reference in its entirety.

### STATEMENT REGARDING FEDERALLY SPONSORED RESEARCH OR DEVELOPMENT

This invention was developed under Contract No. DE-NA0003525 awarded by the United States Department of Energy/National Nuclear Security Administration. The Government has certain rights in this invention.

### BACKGROUND OF THE INVENTION

The invention relates generally to wind turbine blade design and construction.

Wind turbines convert the kinetic energy of wind into electrical energy. Wind turbines include one or more blades that rotate when oncoming wind strikes the blades. The flow of wind over the wind turbine blades generates lift and provides torque to generate power. As such, the amount of energy that a wind turbine can extract from the wind is directly related to the lift generated on the blades. The amount of lift generated on the blades depends on a number of factors. These factors include speed of the wind, lift coefficient of the blades, planform area of the blades, and air density of the wind.

One technique used to increase lift, and thereby increase energy extracted by the wind turbine, is to increase the platform area of the blades. However, larger blades are more expensive and may present structural issues in the wind turbine due to their greater weight. Another technique to increase lift is to pitch the blades such that the angle of attack of the blade is increased, which increases the lift coefficient. However, increasing the angle of attack above a critical angle of attack may result in air flow separation over the blades resulting in stalling the blades. When stall occurs, lift generated by the blades decreases significantly and a large component of torque is lost.

What is needed are wind turbine blades that provide increased lift over a range of operating conditions, while also being robust to erosion and lightning strikes, thus reducing the cost of the electricity produced by overcoming the deficiencies of the prior art. Other features and advantages will be made apparent from the present specification. The teachings disclosed extend to those embodiments that fall within the scope of the claims, regardless of whether they accomplish one or more of the aforementioned needs.

### SUMMARY OF THE INVENTION

The present disclosure is directed to a method of forming a turbine blade wing tip by an additive manufacturing process to form a blade section and/or a winglet.

The present disclosure is further directed to a wind turbine blade tip formed by an additive manufacturing process.

An advantage of the present disclosure is reduced levelized cost of electricity (LCOE) for both new and existing wind turbines.

Another advantage of the present disclosure is that modular tips allow the aerodynamics of the turbine to be tuned to a range of wind conditions, including through the use of winglets.

Another advantage of the present disclosure is that modular tips allow integration of technologies, such as erosion protection, lightning protection, and surface texturing to improve aerodynamic performance and reduce noise generation

Another advantage of the present disclosure is that modular tips allow integration of active technologies such as active flow control devices.

Another advantage of the present disclosure is that additive manufacturing facilitates the following that are difficult to achieve with traditional manufacturing: novel tip and winglet shapes, novel surface texturing to reduce drag or improve lift, improved robustness in areas subject to failure (such as trailing edge separation).

Another advantage of the present disclosure is that additive manufacturing allows customization for sites with different operating conditions.

Another advantage of the present disclosure is that additive manufacturing allows replaceable tips for damaged blades.

Another advantage of the present disclosure is that additive manufacturing allows integration of technologies requiring complex geometric features (e.g. metal leading edge, complex vortex generators potentially also serving as lightning protection, robust weep hole performance, etc.).

Other objects, advantages, and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instruments and combinations particularly pointed out in the appended claims. Alternative exemplary embodiments relate to other features and combinations of features as may be generally recited in the claims.

### BRIEF DESCRIPTION OF THE DRAWINGS

The application will become more fully understood from the following detailed description, taken in conjunction with the accompanying figures, wherein like reference numerals refer to like elements, in which:

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is an illustration of a wind turbine blade constructed according to an embodiment of the disclosure.

FIG. 2 is a schematic of a wing tip blade portion having a VG design upon the surface thereof according to an embodiment of the disclosure.

FIG. 3A illustrates a dimpled pattern and geometry for the winglet according to an embodiment of the disclosure.

FIG. 3B illustrates two of the dimples of FIG. 3A according to an embodiment of the disclosure.

FIG. 3C illustrates a side view of a dimple according to an embodiment of the disclosure.

FIG. 4 illustrates a CFD modeled simulation of boundary layer flow over a blade according to an embodiment of the disclosure.

### DETAILED DESCRIPTION OF THE INVENTION

Before turning to the figures, which illustrate the exemplary embodiments in detail, it should be understood that the application is not limited to the details or methodology set forth in the following description or illustrated in the figures. It should also be understood that the phraseology and terminology employed herein is for the purpose of description only and should not be regarded as limiting.

The present disclosure is directed to an additively manufactured (AM) system-integrated tip (AMSIT) that is integrated into a wind turbine blade. The tip may be designed to be part of the initial turbine blade design, can be added to an existing turbine blade or can be added to an existing turbine blade as a blade repair improvement. The present disclosure is also directed to the wind turbine blade that includes the novel tip. The disclosed wind turbine blades reduce the levelized cost of electricity (LCOE) for both new and existing wind turbines. The blade tip reduces LCOE by increasing turbine performance, reducing capital expenditures (CapEx) (transportation logistics, installation logistics, etc.), and reducing operational expenditures (OpEx) (maintenance, reliability and repair).

According to the present disclosure, the blade tip (tip) includes a blade portion having a first end connected to a turbine blade. The turbine blade may be referred to as a root or base to which the blade portion is attached. In some embodiments, the tip includes a winglet connected to the second end of the blade portion. In other embodiments, the winglet may be connected to the turbine blade root or base.

The winglet is a lifting surface that extends out of the plane of the base or root. In some embodiments, the winglet may extend perpendicularly or at a steep angle to the plane of the blade portion or root. The winglet increases the aerodynamic efficiency of the wind turbine by making the flow around the blade tip more efficient by producing aerodynamic lift while causing less drag, producing increased lift for the same drag, or producing lift in a way that increases power while maintaining bending moment of the blade. Conventional blade manufacturing processes use quasi-planar blade molds that make adding a winglet challenging due to the out of plane geometry of a winglet.

The tip is formed by an AM process. According to this disclosure and claims, additive manufacturing is defined as processes that include particle deposition, powder bed fusion, binder jetting, and particle or material extrusion. The AM process may include heating. Particle deposition includes processes, such as, but not limited to 3-dimensional (3D) printing, and powder bed diffusion. The AM process eliminates many limitations of conventional planar blade manufacturing including the labor-intensive layup of fiber glass or carbon fiber, which is limited by moldable geometries. In comparison, AM processes reduce waste and improves process control by eliminating the need to adhere the two halves of the blades, which often results in weak joints at the trailing edge.

Additive manufacturing enables the inclusion of a winglet in the proposed blade tip design. The winglet may include a continuous extension of the metallic leading edge from the main blade, which may provide additional area for the lightning protection system and erosion resistance that also improves aerodynamic performance. The winglet may be upwind or downwind, as determined by the performance increase and clearance from the tower.

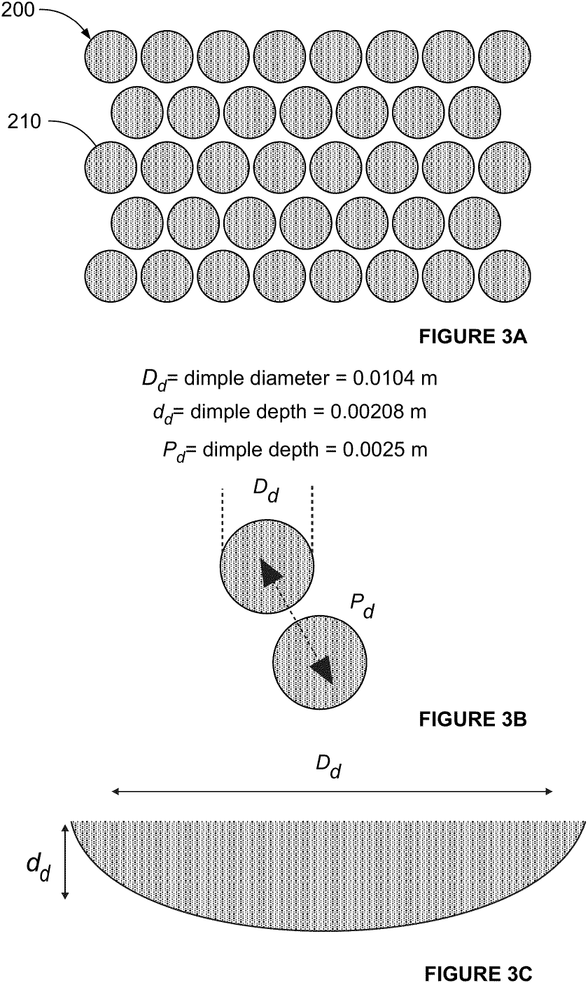

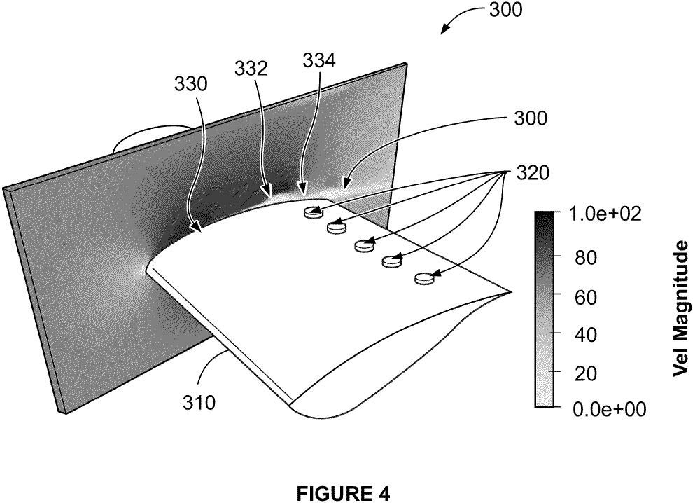

According to an embodiment of the disclosure, the blade tip may include dimples on all or portions of a surface of the blade tip. The dimples may be on the blade tip blade portion and/or winglet. The dimples reduce drag, reduce noise and increase performance by inhibiting boundary layer separation. The dimples scale with the size of the blade, turbine and operating conditions. In an embodiment, the dimple diameter D_{d}, see FIG. 3B, is between 0.0083 and 0.0125 m. In an embodiment, the dimple diameter is 0.0104 +/- 0.001 m. In an embodiment, the dimple diameter is 0.0104 m. In an embodiment, the dimple depth d_{d}, see FIG. 3B, is between 0.00166 and 0.0025 m. In an embodiment, the dimple depth is 0.00208 +/- 0.0005 m. In an embodiment, the dimple depth may be 0.00208 m.

In an embodiment, the dimple pitch p_{d} is between 0.0020 and 0.0030 m. In an embodiment, the dimple pitch is between 0.0025 +/- 0.001 m. In an embodiment, the dimple pitch may be 0.0025 m. Dimple pitch is defined as the cell-center to cell-center distance between two adjacent dimples, see FIG. 3C.

According to an embodiment of the disclosure, the blade tip may include an erosion resistant leading edge that may extend to the winglet. The leading edge may be formed of metal or some other erosion resistant material, such as, but not limited to metals, ceramics, erosion resistant polymer-based materials and carbon based materials. In an embodiment, the leading edge may be formed of stainless steel formed by the AM process. In some instances, the leading edge material may be printed first and the blade material then printed around it. In other instances, the leading edge protection may be added after the tip/winglet is printed, which is facilitated by printing in a groove to accept the leading edge protection.

According to another embodiment of the disclosure, the blade tip may include trailing edge serrations for noise reduction and a thinner trailing edge for performance improvement through drag reduction. Note these serrations could also be extended to the winglet section (not shown). The trailing edge serrations are periodic or aperiodic perturbations to the trailing edge. In an embodiment, the serrations have a generally triangular shape or other geometry to aid in noise reduction. The serrations have a length extending from the trailing edge that scales with the size of the turbine and its blades. In an embodiment the serrations have a length that scales with the size of the turbine and its blades. The serrations have a width that scales with the size of the turbine and its blades.

According to another embodiment of the disclosure, the blade tip may include vortex generator (VG) features. The VG features may be formed into the blade tip during the AM process or added as a feature to the AM generated tip. In an embodiment, the VG features may extend the length of the laminar boundary layer over the wind turbine blade. In an embodiment, the VG features may extend over all of or partially over the length of the laminar boundary layer.

The primary purpose of the VG features is to reduce aerodynamic drag on the tip. A secondary purpose of the VG features is as a lightning receptor by replacing one or more VGs with metal fasteners that penetrate from the exterior to interior of the tip and connect to the down conductor wire. The VG features can be any shape and arranged in any pattern that best helps the flow over the suction side of the blade avoid a stall condition by re-energizing the boundary layer with high momentum fluid from the freestream flow. In an embodiment, the VG features may be, but are not limited to tabs, posts, cylinders, triangles, wedges, and diamonds.

According to another embodiment of the disclosure, the blade tip may include a lightning protection system cable (cable) that connects to the lightning system of the blade. The cable may be laid into the blade portion during the 3D printing of the blade portion or the cable may be printed into the blade portion.

The present disclosure is further directed to an AM process or method that allows novel overall blade designs as well as enhanced tip integration. Transportation constraints that hinder large blade delivery are addressed with the segmented and modular design where the tip could be attached at the site where the turbine is raised. AMSIT applies to both new and retrofit applications. AMSIT technology improves aerodynamic performance, durability (e.g. leading-edge erosion), aeroacoustics, lightning protection, and reliability and strength (due to novel structural configurations) over existing wind turbine blade tips. The additively manufactured blade tip addresses transportation constraints of large blades with a segmented design, where the tip or outer part of the blade is attached to the inboard blade, which may also be referred to as the root or base blade.

The material may be polymers and resins, such as, but not limited to nylon, high performance thermoplastic (PEI - polyetherimide, PEKK- polyetherkeytoneketone), polycarbonate. Where some polymers like PEKK have electrostatic discharge properties. The materials may include strengthening additives such as, but not limited to carbon fibers, various filaments, carbon nanotubes, fiberglass, and metal powders. In an embodiment, the blade tip is formed in a single additive manufacturing process, in other words, formed together. In another embodiment, the blade tip blade portion and the winglet may also be printed in portions to combine the highest quality surface finishing on some surfaces that require the best aerodynamics (e.g. leading and trailing edge) with the highest strength print in other sections (e.g. internal structure). This gives the option to tune the properties to the most important need of each portion of the design.

All leading edge, trailing edge, and tip area can be made from a range of additive manufacturing materials and in some embodiments these materials are conductive (such as metal or carbon) and are integrated into the lightning protection system. Any erosion resistant material such as, but not limited to metals, ceramics, polymer-based erosion materials, carbon based materials, can be used as a leading edge that can extend to the winglet. Any metal or conductive material, such as but not limited to metals, such as copper, could be integrated into the lightning protection system and connected to the down conductor.

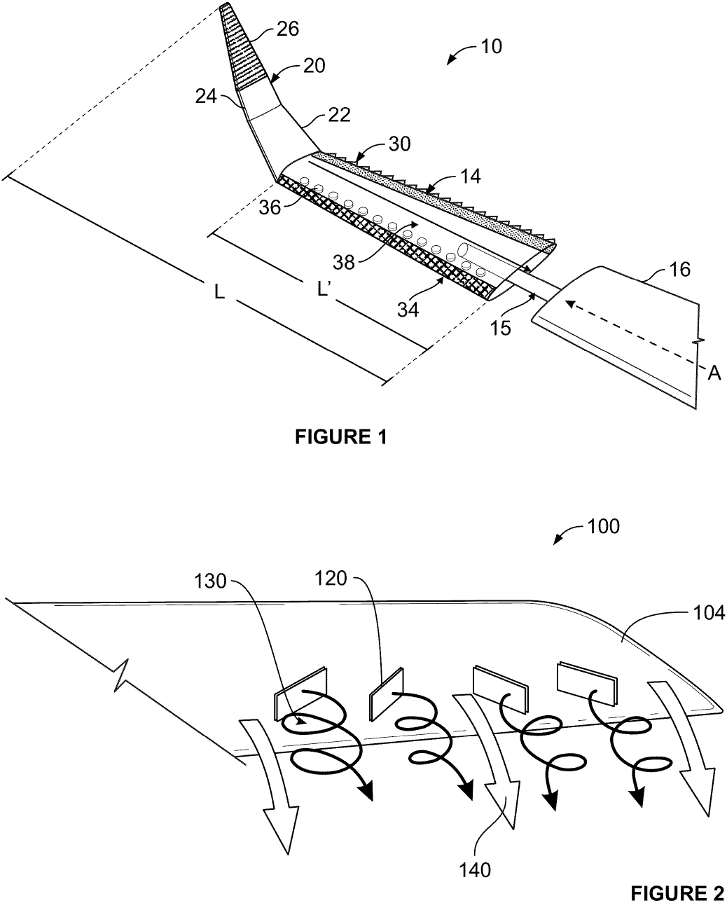

FIG. 1 illustrates a blade tip 10 according to an embodiment of the invention. As shown in FIG. 1, the blade tip 10 is shown in a joining relationship to turbine blade (blade) 16. In this exemplary embodiment, a spar 15 is used to join the blade tip 10 to the blade 16. In other embodiments, one or more spars, pins or other alignment/strengthening components may be used in aligning/strengthening the joint between the blade tip 10 and the blade 16. As will be appreciated by one of ordinary skill in the art, the blade tip 10 is further joined to the blade 16 by adhesives, pins, fasteners.

As can further be seen in FIG. 1, the blade tip 10 includes a blade tip blade portion (blade portion) 14 and a winglet 20. The blade portion 14 has been formed by 3D printing. In other embodiments, the blade portion 14 may be formed by other additive manufacturing processes as discussed above. The blade portion 14 includes a leading edge 34. In this exemplary embodiment, the leading edge 34 is formed of stainless steel that was formed by 3D printing with the other portions of the blade portion 14. In other embodiments, the leading edge 34 may be formed by 3D printing, additive manufacturing such as, but not limited to 3D printing, or metal sheet forming and then attached to the blade portion 14. In other embodiments, the leading edge 34 may be omitted.

The blade portion 14 further includes a trailing edge 30 that has been formed into the blade portion during 3D printing. In this exemplary embodiment, the trailing edge 30 is formed of triangular tabs that form a serrated geometry that extends away from the blade portion 14. In other embodiments, the trailing edge 30 may have tabs with and inner or outer ogive shaped geometry. In this exemplary embodiment, the serrated edge covers the full trailing edge. In other embodiments, the serrated trailing edge may partially or fully cover the trailing edge and/or may extend into the trailing edge of the blade tip. In other embodiments, the trailing edge 30 may be omitted.

The blade portion 14 further includes active control (AC) features 36 that extend the length of the laminar boundary layer over the blade portion. The primary purpose of the AC features 36 is reducing aerodynamic drag. In another embodiment, the AC features 36 can behave as a lightning receptors by replacing one or more ACs with metal fasteners that penetrate from the exterior to interior of the tip and connect to the down conductor wire. In this exemplary embodiment, the VG features are openings in the surface that penetrate into the blade portion interior. Air is pumped and/or pressurized in the blade portion to exit the openings to interact with the flow of air over the blade portion thereby extending the length of the laminar boundary layer over the blade portion by mixing the flow. In this exemplary embodiment, the AC features are circular. In other embodiments, the VG features may be rectangular, tabs, or triangular. The AC features can be arranged in any pattern that best helps the flow over the suction side of the blade avoid stall by re-energizing the boundary layer with high momentum fluid from the freestream flow. The AC features 36 are formed in the blade portion 14 during the AM process of the blade portion 14. In this exemplary embodiment, the AC features 36 are shown extending substantially fully along the length axis of the blade portion 14. In other embodiments, the AC features 36 may extend partially or substantially along the length axis. In other embodiments, the AC features 36 may be omitted.

In this exemplary embodiment, the blade portion 14 further includes a lightning protection system cable 38. In this exemplary embodiment, the cable 38 is a wire laid into the blade portion 14 during the printing of the blade portion 14. In other embodiments, the cable 38 may be printed into the blade portion 14. In this exemplary embodiment, the cable 38 is a copper wire. In other embodiments, the cable 38 may be a metal, such as, but not limited to copper, aluminum or other conductive material, such as, but not limited to carbon, such as carbon nanotubes. In other embodiments, the cable may be omitted.

The length of the blade tip scales with the size of the blade, turbine and operating conditions. In an embodiment, the length L of the blade tip is between 3-20% of the length of the overall wind turbine blade. The blade portion 14 has a length L′ along the turbine blade axis A. The length L′ is between 3-20% of the length of the overall wind turbine blade.

The blade portion 14 is built by additive manufacturing methods as defined above The blade portion 14 is formed of polymers and resins as discussed above with features such as, but not limited to the leading edge, trailing edge, VG features and lightning features formed into the additive manufacturing process, meaning that the additive manufacturing process forms the leading edge, trailing edge, AC features, VG features and lightning features formed into the blade portion.

As can further be seen in FIG. 1, the blade tip 10 includes winglet 20. In this exemplary embodiment, winglet 20 includes an inboard section 22, a mid-section 24 and a tip section 26. Each section of the winglet 20 may be formed of one or more materials including those discussed as used in forming the blade portion 14. The materials may be chosen to allow for transition in and across the sections of strength, flexibility, rigidity, fatigue resistance, electrical conductivity and thermal expansion. In other embodiments the winglet sections may be smoothly connected with many additional segments. In other embodiments the winglet sections may have many sections approaching a smooth curve. In other embodiments, the winglet may be a single smoot curve.

In this exemplary embodiment the inboard section 22 is formed using the material of the blade portion. The mid-section 24 is formed of the same material as the blade section with strength/stiffener additives. The tip section 26 is formed of the same material as the blade portion with a layer of a conductive lightning protective material. In other embodiments, the winglet may be formed of any combination of materials to provide engineered design criteria of the winglet, including, but not limited to strength, lightening protection and drag reduction. As the sections are formed by additive manufacturing, the section material may gradually transition from section to section. In an embodiment, all three sections are formed of the same material. In this exemplary embodiment, the winglet 20 has three sections. In other embodiments, the winglet 20 may have one or more sections. In an embodiment, the winglet 20 may have one to a hundred or more sections. In this exemplary embodiment, the angle from the axis A at the end of the blade section away from the blade to the tip of the tip section is 45°, which is accomplished by ramping up the sections of the winglet to a height H above the plane of axis A. In other embodiments, the angle may be from 90° (vertical to the plane) to less than 180° to the plane. As with the blade portion 14, the materials of the winglet 20 may include strengtheners, stiffeners and other materials of desired characteristic. In other embodiments, all or portions of the aerodynamic surface of the wingtip are made of or coated in (through 3D printing or other processes) a conductive material, such as a metal, to provide lightning protection by giving the lightning a path to spread across the surface and to a grounded conductive part of the lightning protection system.

As discussed, winglets can be combined with any of the other embodiments disclosed herein. For example, a winglet may include a trailing edge treatment to reduce noise or a winglet may include a receiver for lightning. Any of these may be additively manufactured. Winglets may also be additively manufactured with novel or non-traditional trailing and/or leading edges to accelerate tip vortex destabilization and decay. Winglets may be used for load control and wake mixing with the possibility of different winglets on different tips of blades.

### Aerodynamic Improvements Via Surface Texturing and Features

In an embodiment, the includes vortex generator (VG) features to extend the length of the laminar boundary layer over a wind turbine blade for the primary purpose of reducing its aerodynamic drag. A secondary purpose is that the VG can behave as a lightning receptor. A schematic of a VG design according to the present disclosure is shown in FIG. 2. As can be seen in FIG. 2, the VGs are rectangular tabs extending away from the blade section surface. In other embodiments, the VGs may be rectangular, square, triangular, or other planar geometries. In other embodiments, the VGs may be non-planar, such as, but not limited to cylindrical, oval, square, rectangular and triangular protrusions. The size of the VGs is dependent on the size of the blade, turbine and the operating conditions. Cylindrical VGs are discussed in more detail below.

VGs reduce aerodynamic drag. In an embodiment, dependent upon material, VGs may act as a lightning receptor. For the case where the VG is a cylinder protruding from the surface, the diameter of the optimized VG was obtained using the right sized dimpling (RSD) software with input for an exemplary wind turbine blade under exemplary conditions was based on the following:
X_{char} = characteristic length of the blade chord length = 0.64 m,
U_{char} = relative air velocity = 75 m/s,
nu_{char} = year-averaged air kinematic viscosity for Dallas, Texas = 1.51×10⁻⁵ m²/s.

The RSD calculates that D = 0.0178 m.

Once D is known, the VGs were shaped as cylinders to divert turbulent energy from the boundary layer onto the spanwise region of the blade. This disperses the turbulent kinetic energy, and hence increases the laminar boundary layer length across the blade chord. Consequently, the high-drag physics of turbulent boundary layer separation is avoided.

The height H of the cylinder is designed as follows:

Most turbulence energy production is in the boundary layer range where the production term is the largest, within the approximate range of 7 ≤ y⁺ ≤ 25, where y⁺ is the dimensionless number formed via the product of the distance that is normal to the wing surface times the friction velocity, and divided by the kinematic viscosity. Here the novel utility of specifying VG height based on a y⁺ criterion is that its height corresponds to the boundary layer height where the most turbulence is generated. Moreover, having H> (y⁺= 5) is acceptable, as eddy production energy drops exponentially as y⁺ increases. Hence, a novel application is that the minimum H of a convex cylinder VG must be H = (y⁺ ≥ 25) for it to effectively disperse the turbulent energy production. In addition, the VG could also be shaped into a more aerodynamic basic shape, such as an elongated hemi-sphere about its axis of symmetry.

For flow over exterior surfaces, the transition from laminar to turbulent flow is reached when the Reynolds number (Re) reaches Re_{crit} = 500,000. To ensure that a turbulent point is reached on the blade and to ensure that the VGs are effective, the VGs were placed at the location where Re = 1.1Re_{crit} = 550,000. This placement prevents the newly-formed turbulent flow in the boundary layer from detaching and thereby generating excessive drag. Hence, the VG placement distance was calculated by imposing a conservative critical limit on Re, as follows,

$$R e = 1.1 R {e}_{c r i t} = 1.1 {X}_{c r i t} {U}_{c h a r} / n {u}_{c h a r} = 550 , 000$$

where

$${X}_{c r i t} = {X}_{V G} = \text{conservative laminar-to-turbulent transition distance,}$$

$${U}_{c h a r} = \text{relative air velocity} = 75 \text{m} / \text{s} ,$$

Hence,

$${X}_{V G} = 550 , 000 n {u}_{c h a r} / {U}_{c h a r} = 0.111 \text{m} \text{.}$$

The pitch (p) between the cylinders is estimated in such a way as to provide cylinder placement that provides the least amount of perturbation to the blade surfaces as possible. The pitch can be determined using computational fluid dynamics (CFD) models using the dynamic Smagorinsky large eddy simulation turbulence model. The CFD model also demonstrates the reattachment of the turbulent boundary layer near the VGs. However, the magnitude of p can also be estimated from theory in a novel approach presented herein, thereby eliminating expensive and time consuming simulations.

To calculate p, a novel assumption is made to estimate D_{VP} first, which is the diameter of the vortex pair generated by the VGs. More specifically, the counter rotating vortex pair is hypothesized to be akin to an axisymmetric jet, and because the VG generates vortex pairs, a factor of 2 is applied. In particular, it is known in the literature that an axisymmetric turbulent jet diameter expands over length x as,

$$\begin{matrix}{D}_{a x i} = 0.11 x \text{, according to Blevins, R} \text{. D} \text{., Applied Fluid Dynamics} \\ \text{Handbook, Krieger Publishing Co} \text{.,} \\ \text{1992} \text{.}\end{matrix}$$

Hence, applying the novel assumptions for the vortex pair over the entire path travelled by the vortex pairs, then

$$x = \left({X}_{c h a r} - {X}_{V G} - D\right)$$

and thus,

$${D}_{V P} = 0.11 \left({X}_{c h a r} - {X}_{V G} - D\right) .$$

Hence,

$$p \approx 2 {D}_{V P} = 0.22 \left({X}_{c h a r} - {X}_{V G} - D\right)$$

Therefore,

$$p \approx 0.112 \text{m,}$$

which is very consistent with the CFD simulations.

FIG. 3A illustrates a staggered row dimple pattern and geometry that reduces aerodynamic drag in the near-vertical section of the winglet. In other embodiments, this dimple pattern may be used on one or more sections of the winglet and/or blade portion 14. FIGS. 3B and 3C illustrate dimple parameters as discussed earlier in the disclosure.

The near-vertical winglet surface can be engineered with concave dimples to reduce its aerodynamic drag. The dimple diameter D_{d} was obtained by once again applying the RSD copyright. The RSD input was based on the following:
Characteristic length X_{char} based on the blade chord length. X_{char} = 0.25 m.
U_{char} = relative air velocity = 75 m/s,
nu_{char} = year-averaged air kinematic viscosity for Dallas, Texas = 1.51×10⁻⁵ m²/s.

This results in the following RSD-calculated dimple geometry:

$${D}_{d} = 0.0104 \text{m,}$$

$${d}_{d} = 0.00208 \text{m, and}$$

$${p}_{d} = 0.0025 \text{m} \text{.}$$

Referring again to FIG. 1, active flow control through blowing and suction through jets or ports 36 in the surface of the blade may also be strategically combined with surface texturing for improvements to aerodynamic performance and/or noise reduction greater than either alone. Such active flow controls can quickly respond to changes in incoming wind conditions and help the boundary layer stay attached to the blade, preventing stall. Surface texturing could also be combined with other methods to reduce noise. A dimple used for aerodynamic improvements reduces trailing edge noise, for example. The texturing could also be optimized on the winglet to reduce shed tip vorticity, which could improve aerodynamic performance and reduce tip vortex noise.

Air flow can be distributed through an internal network of channels connected to surface orifices. Because of the AM technique, the complexity of the flow network can be optimized to perform the flow regulation of the airfoils with high efficiency. Channels can be pressurized or under vacuum to create the flow modifications. When pressurizing, the air exiting the orifices in the skin is often designed as air jets, providing both boundary layer momentum for the airfoil because of the blowing in itself, but also mixing momentum as these can be oriented as air jet vortex generators. Both increase the lift force on the airfoil section. When providing suction, orifices in the skin will “suck dead air” out of the boundary layer of the airfoil and enhance the performance with drag reduction, improving the performance of the airfoil section and therefore the turbine power efficiency. By micro-managing a network of channels and orifices, the active control of the system can be enhanced.

### Aeroacoustic Noise Reduction Via Trailing Edge Treatments

According to another embodiment of the disclosure, a trailing edge device for noise reduction is disclosed that is integrated to the main tip through 3D printing. The device can be made from a variety of materials. One embodiment is of a conductive material that is integrated with the lightning protection system. In another embodiment, the trailing edge noise devices are printed in one material with a mechanical fastener system as part of the printed design that provides mechanical connection of a conductive surface material or conductive section of the trailing edge device that also provides a conductive connection to the lightning protection system.

One source of noise from wind turbines is due to unsteady aerodynamic processes of the rotor and is considered the dominant noise source from modern turbines. This noise can, in turn, be divided into two sources: airfoil self-noise from the interaction of the airfoil or blade with the nominally steady inflow and turbulent inflow noise form the disturbance of turbulent wind fluctuations by the blades. The airfoil self-noise has been further divided into multiple sources, the two most relevant being trailing edge noise and blade tip vortex noise. Previous studies have identified trailing edge (TE) noise as the dominant noise from aerodynamic sources.

3D printing can allow for thinner TE and non-straight TE, both of which can reduce noise and potentially drag as well. A trailing edge noise treatment system is proposed to be made through the 3D printing process. This trailing treatment can be made with a variety of materials, some can be conductive and integrated with the lightning protection system.

As trailing edge noise is the dominant noise source, the improvements listed below are generally referred to as trailing edge treatments, though the actual modifications may be made anywhere on or within the blade tip to reduce the trailing edge noise. The commonality of all these improvements is that they would reduce trailing edge noise and, in some cases, also the tip vortex noise, and could be additively manufactured as part of the blade tip.

By 3D printing the trailing edge noise treatment in the integrated tip, the risk of the trailing edge devices falling over is reduced. Additionally the cost can be reduced, since the devices do not require separate manufacturing and installation steps.

In an embodiment, the trailing edge devices can be made of a conductive material or have a conductive material mechanically fastened to them through a 3D printed connection, allowing the trailing edge to be part of the lightning protection system. Having a larger area of lightning protection can reduce the risk of lightning damaging other parts of the blade or systems within the blade.

The following paragraphs discuss various trailing edge embodiments:
Trailing edge serrations: changing the trailing edge of a rotor blade from its typically continuous or smooth edge to one with serrations or similar periodic or aperiodic perturbations has been demonstrated to reduce trailing edge noise. In this embodiment, this treatment could be additively manufactured and could be extended to the winglet as well. Additionally, the trailing edge devices are able to be optimized in shape, length, and width to the unique noise signature of a given airfoil.
Trailing edge brushes: similar to trailing edge serrations, trailing edge brushes (also known as slits) can be attached to the trailing edge to dampen turbulent fluctuations. In this embodiment, the brushes may be additively manufactured as an integral part of the blade tip, or the blade tip may be additively manufactured to receive the trailing edge brush for installation, or both may be additively manufactured and the brushes installed on the blade tip afterwards. In an embodiment, these are extended to the winglet.
Porous trailing edges: Adding porosity to some or all of the rotor blade surface, in particular near the trailing edge, may also reduce trailing edge noise. In this embodiment, the porosity would be integrated into the additively manufactured design of the blade tip and could be extended to the winglet.
Bio-inspired edge treatments: Bio-inspired edge geometries such as tubercles inspired by whale flippers or patterns inspired by wing feathers have been suggested to reduce trailing edge noise. These can be additively manufactured as part of the blade tip and could be extended to the winglet.
Combinations: Any of the above may be combined. For example, trailing edge serrations could be made of brushes or active flow control could be integrated with a bio-inspired edge. Any of these could be additively manufactured into the blade tip and could be extended to the winglet.

### Leading-Edge Erosion and Icing Protection

The metal or ceramic leading edge will eliminate power losses due to surface degradation and avoid the leading-edge protection tape failures seen by wind farm owners and operators.

Leading edge erosion is a prominent issue in the wind turbine industry, causing increased maintenance costs and annual energy production loss of up to 2% for even moderate erosion. Erosion of the blade surface is caused primarily by fatigue damage due to the impact of rain drops at the blade tips, where the blade is moving at the highest velocity. The mitigation of leading edge erosion performance loss and reliability concerns require either costly repair or the application of a protection tape, both requiring regular maintenance intervals. Helicopters typically avoid the issue of leading edge erosion by using metallic leading edges on the rotor blades, but such technology has been too expensive to integrate into conventional wind turbine blade manufacturing processes.

Additionally, icing is a growing concern for wind plant and grid operators, as it can cause entire wind plants and regions of wind plants to go offline, occasionally in times of critical need for power generation. Metallic, ceramic, or hybrid leading edge materials allow for resistive heating to resist ice, similar to modern commercial aircraft. These materials are challenging to integrate into the manufacturing process and extremely difficult to maintain and repair.

According to an embodiment, a metallic leading edge protection device is attach to the main blade through a mechanical attachment system. A 3D printed mechanism in the blade will provide the other end of the mechanism. The attachment mechanism is connected to the lightning protection system through conductive connectors. A less conductive ceramic material in another embodiment can also be mechanically attached to the leading edge or integrated in the 3D printing process to provide integrated, long-life leading edge protection, although without the integrated lightning protection. In another embodiment, the leading edge protection material is metallic, ceramic, or a hybrid and is used as a resistive heating element to resist ice accumulation.

The metallic or ceramic leading edge material can also be part of the 3D printing process. Thus, aerodynamic surface modifications can be included in the design, for example the surface could include concave and/or convex dimples made of the protective material. Another example is ripples that can facilitate better aerodynamic performance.

The metallic or ceramic leading edge material has resistance to leading edge damage far in excess of traditional materials, beyond 20-30 years. Attachment of the metallic or ceramic material to the dissimilar composite blade material will outlast the lifetime of adhesives through the use of mechanical connection. The 3D printing process allows for this mechanical connection to be part of the blade with an aerodynamically smooth transition, reducing drag compared to existing add-on leading edge protection solutions.
The metallic leading edge provides additional lightning protection over conventional lightning receptors, as the greater the size of the receptor area, the greater the chance of lightning hitting it.
Having a metal leading edge could help attract lightning over a standard receptor used on conventional wind turbine blades.
The metallic, ceramic, or hybrid leading edge can also be heated through electrical currents to provide resistance to ice buildup.
The metallic or ceramic leading edge can also be part of the 3D printing process, providing integration of the leading-edge protection and main blade.

Leading edge erosion protection can be combined with a lightning protection system. For example, by switching materials during the additive manufacturing, a metallic leading edge for erosion protection could be electrically connected to the lightning protection system for safe routing of lightning. Using the leading edge erosion protection can increase the available area for lightning reception. The leading edge can also be additively manufactured in such a way that it provides erosion protection while also contributing to aerodynamic performance improvements and/or noise reduction through, for example, the use of novel leading edge geometries, for example tubercles inspired by whale flippers.

### Structural Improvements

Additive manufacturing facilitates structural improvements by allowing printing of unique geometries and combinations of materials that could not be created through traditional manufacturing techniques.

Traditionally, the structure of a wind turbine blade can be provided by internal supports, the external skin, or a combination of these. With additive manufacturing, the distinction of these parts is more arbitrary as the blade may be manufactured largely as a single piece meeting all engineering requirements without need for much, or possibly any, assembly.

Improvements of additive manufacturing include:
strength to weight ratio
   ◯ because the geometry can be 3D printed in any configuration, strength can be added through thin spars or supports without adding significant mass, reducing loads from the tip on the rest of the blade.
unique materials
   ◯ composites such as chopped carbon fiber epoxy can be 3D printed in configurations that would not be possible through traditional fiber-epoxy layup manufacturing techniques, providing high strength and novel geometries.
unique material combinations
   ◯ AM and AM in conjunction with other materials processing techniques can be used to create components that have multiple functions (e.g. a metal leading edge that also provides structural rigidity to the tip).
custom retrofit options
   ◯ the structural strength can be designed into the external shell, internal supports (ribs, spars, beams, frame, etc.), or a combination.
   ◯ retrofit applications can be customized to mate to the design of the existing blade, with loads supported as appropriate to either internals or the shell.
   ◯ retrofit or repair applications could utilize internal supports to mount a portable 3D printer and print the new tip in the field.
Bio-inspired designs

Additive manufacturing allows for novel geometries that cannot be produced through other means of manufacturing. This would allow for testing and use of bio-inspired designs with advantages in terms of their strength to weight ratios and their spatial use of different materials. For example, bones are largely hollow, but have an internal support structure that has been shown to largely follow the lines of principal stress and a similar structure could be additively manufactured inside the blade. Where necessary, and only where necessary, different materials that add strength or reduce weight, for example, could be used.

### Lightning Protection

According to an embodiment, a metal leading edge can help attract lightning over a standard receptor used on conventional wind turbine blades. Conventional wind turbine lightning systems consist of one or multiple metal receptors, which are connected to an inner down conductor cable that guides the strike current into the cable down to the hub and into the tower, where it can then move into the ground via the turbine grounding system. In some instances, the lightning receptors are equipped with lightning strips on the surface. These are made of small metal pieces, not directly connected to the system, but enabling an easier strike channel to open near the receptor point, thus increasing the chance of the strike current being attracted to the protection system, rather than penetrating the skin. Unfortunately, these strips do not last long and are considered a consumable. An alternative method is to embed net inside the skin, this protects the inner part, but is also often damaged by similar mechanisms. Finally, the very last point of the blade, namely the tip can have a metal cap over the skin, and connect to the protection system, but such systems are not well integrated with complex aerodynamic tip shapes.

Lightning protection systems prevent damage of the structural elements of a wind turbine blade by preventing large currents from being conducted in the structure, thus heating the material and thus damaging the material.

By integrating lightning protection with the manufacturing of the elements described here, the lightning protection elements can be aerodynamically and structurally integrated trough a multi-material printing process. More complex and optimized receptor designs (shape and materials) can be integrated. Specifically:
A metallic cap can be printed around the tip and connected to the internal wire system, making performance tip improvements dual function as a lightning receptor.
Receptor points for lightning strike can be printed into the skin and connected to an internal conductor, providing a robust integration.
Aerodynamic dimples can be metal printed and connected to function as lightning strips, with a robustness not included in existing lightning strips, while at the same time providing an aerodynamic function.
Leading edge and trailing edge can be printed in metal and connected to the internal conductor(s) and provide additional lightning.

As any element of the additively manufactured blade can be produced with a conductive material, many of the inventions above could be integrated into the lightning protection system. For example, elements of the surface texturing or the leading edge erosion protection or the winglet itself could all function concurrently as lightning receivers. As different materials can be spatially distributed with ease in additive manufacturing, the conduction system for the lightning protection system can be directly integrated into the blade as opposed to separately manufactured and installed.

### Distributed Aerodynamic Controls

Distributed aerodynamic controls (DAC) have the potential to alleviate fast-acting gust loads on wind turbines. An example of an aerodynamic control (AC) is shown as 36 in FIG. 1 and described in the discussion thereof. Larger blades have reduced the speed at which conventional blade pitch systems can control loads. The primary reasons for slow adoption of DACs has been concerns about cost and complexity of integration into the conventional manufacturing process and long term reliability.

DACs are devices that change the airflow over a local area of wing or blade. Examples are flaps, tabs, jets, and spoilers. These are in contrast to fixed aerodynamic devices (e.g. vortex generators and dimples), which are non-controllable, and pitching, which effects the entire blade simultaneously. DACs have the effect of changing lift, drag, and pitching moment in different amounts depending on the design. These devices have been shown in both models and field experiments to have a large effect on high frequency load fluctuations, but to date, have not been adopted in the wind industry due to concerns about cost and reliability.

An additively manufactured tip allows for sensors and mechanisms to be manufactured directly into the tip or for attachments for sensors and mechanisms to be manufactured directly into the tip. This allows for easier maintenance of sensors and devices through either having access to the devices and sensors themselves or through replacement of the entire tip.

While the exemplary embodiments illustrated in the figures and described herein are presently preferred, it should be understood that these embodiments are offered by way of example only. Accordingly, the present application is not limited to a particular embodiment but extends to various modifications that nevertheless fall within the scope of the appended claims. The order or sequence of any processes or method steps may be varied or re-sequenced according to alternative embodiments.

It is important to note that the construction and arrangement of a blade tip as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

It should be noted that although the figures herein may show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the application. Likewise, software implementations could be accomplished with standard programming techniques with rule-based logic and other logic to accomplish the various connection steps, processing steps, comparison steps and decision steps.

1. A method of forming a turbine blade wing tip, comprising:
forming by an additive manufacturing process a blade section.

2. The method of claim 1, wherein the additive manufacturing process is selected from the group consisting essentially of particle deposition and particle or material extrusion processes.

3. The method of claim 2, wherein the particle deposition process is 3D printing.

4. The method of claim 1, further comprising:
forming a winglet by additive manufacturing.

5. The method of claim 4, wherein the winglet is structural formed with the blade section.

6. The method of claim 1, wherein the blade section includes surface dimples formed into a surface of the blade section.

7. The method of claim 4, wherein the winglet includes surface dimples formed into a surface of he winglet.

8. The method of claim 1, further comprising:
forming by additive manufacturing vortex generators on a surface of the blade section.

9. The method of claim 1, further comprising:
forming active controls into a surface of the blade section.

10. The method of claim 1, further comprising:
forming a leading edge of an erosion resistant material into the blade section.

11. A wind turbine blade tip comprising a blade section formed by the method of claim 1.

12. A wind turbine blade tip, comprising:
an additively manufactured wind turbine blade portion or winglet.

13. The blade of claim 12, wherein the turbine blade tip comprise a blade section.

14. The blade of claim 12, wherein the turbine blade tip comprises a winglet.

15. The blade of claim 14, wherein the winglet is seamlessly joined to the blade section as the blade section and winglet are additively manufactured together.

16. The blade of claim 12, wherein the blade tip comprises additively manufactured trailing edge treatments.

17. The blade of claim 12, wherein the wind turbine blade tip comprises surface dimples.

18. The blade of claim 12, wherein the wind turbine blade tip comprises vortex generators.

19. The blade of claim 12, wherein the wind turbine blade tip comprises active controls.

20. The blade of claim 12, wherein the wind turbine blade tip comprises a leading edge of a material having an erosion resistance greater than other portions of the wind turbine blade tip.
